(19) United States
(12) Patent Application Publication
(10) Pub. No.: US 2015/0309681 A1
(43) Pub. Date: Oct. 29, 2015

(54) Depth-based mode switching for touchless gestural interfaces

(71) Applicant: Google Inc., Mountain View, CA (US)

(72) Inventors: Christian Plagemann, Palo Alto, CA (US); Alejandro Jose Kauffmann, San Francisco, CA (US); Joshua Robin Kaplan, San Francisco, CA (US)

(73) Assignee: Google Inc., Mountain View, CA (US)

(21) Appl. No.: 14/259,231

(22) Filed: Apr. 23, 2014

(51) Int. Cl. G06F 3/0484; G06F 3/0481; G06F 3/01

(52) U.S. Cl. CPC G06F 3/0484; G06F 3/017; G06F 3/0481

(57) ABSTRACT

Disclosed are techniques for detecting a gesture performed at a first distance and at a second distance. A first aspect of a target may be manipulated according to the first gesture at the first distance and a second aspect of the target may be manipulated according to the first gesture at the second distance.

### BACKGROUND

Gesture-based systems are widely popular in gaming systems and allow users to interact with content shown on a display, such as a video game, without having to use a remote control. More recently, smartphones have been imbued with gesture controls that are recognized by a phone's camera or that are based on physical movement of the device as detected by the phone's inertial measurement unit (“IMU”). While gesture-based systems exist for navigating a computer operating system and applications executed thereon, such systems tend to be cumbersome and inadequate as compared to conventional navigation that utilizes a keyboard and mouse.

### BRIEF SUMMARY

According to an implementation of the disclosed subject matter a first gesture may be detected that is performed at a first distance from a reference point at a user. The first gesture may be detected at a second distance from the reference point at the user. A first aspect of a target on a display may be manipulated according to the first gesture at the first distance. A second aspect of the target on the display may be manipulated according to the first gesture at the second distance.

In an implementation, an indication of a first gesture that includes a motion may be received. The indication of the first gesture may include a first position of a hand relative to a reference point. An indication of a second gesture that substantially includes the motion may be received. The indication of the second gesture may include a second position of the hand relative to and closer to the reference point. A user interface may be adjusted from control of a first object according to the first gesture to control of a second object according to the second gesture.

A gesture may be received on a first position on a z-axis according to an implementation. A first function may be performed on a first target based on the gesture. A movement of a hand along the z-axis may be detected. A control may be changed from the first target to a second target based on the movement of the hand along the z-axis. The gesture may be received at a second point on the z-axis. A second function may be performed on the target.

A system is disclosed that includes a database for storing sensor data from a camera, a camera sensor configured to send sensor data to the database, and a processor connected to the database. The processor may be configured to detect a first gesture performed at a first distance from a reference point at a user and detect the first gesture performed at a second distance from the reference point at the user. The processor may manipulate a first aspect of a target on the display according to the first gesture at the first distance. The processor may manipulate a second aspect of the target on a display according to the first gesture at the second distance.

In an implementation, a system is provided that includes a computer-readable storage device for storing data pertaining to gestures. A processor may be connected to the storage device. The processor may be configured to receive an indication of a first gesture that includes a motion. The indication of a first gesture may include a first gesture comprises a first position of a hand relative to a reference point. The processor may receive an indication of a second gesture that includes substantially the motion. The indication of the second gesture may include a second position of the hand relative to and closer to the reference point. The processor may adjust a user interface from control of a first object according to the first gesture to control of a second object according to the second gesture.

According to an implementation, a system is provided that includes a computer-readable storage device for storing data pertaining to gestures. A processor may be connected to the storage device and configured to receive a gesture on a first position on a z-axis and perform a first function on a first target based on the gesture. The processor may detect a movement of a hand along the z axis and change control from the first target to a second target based on the movement of the hand along the z axis. It may receive the gesture at a second point on the z axis; and perform a second function on the second target.

In an implementation, a system according to the presently disclosed subject matter includes means for detecting a first gesture performed at a first distance from a reference point. The means for detecting the gesture may include, for example, a camera capable of detecting the gesture. It may contain the means for detecting the first gesture performed at a second distance from the reference point. The system may include a means for manipulating a first aspect of a target on a display according to the first gesture at the first distance and manipulating a second aspect of the target on the display according to the first gesture at the second distance. For example, a processor communicatively coupled to a camera capable of detecting gestures may determine a distance between a reference point and a user's hand as disclosed herein.

As disclosed, a first gesture performed at a first distance from a reference point at a user may be detected and the first gesture performed at a second distance from the reference point at the user may be detected. A first aspect of a user interface element may be manipulated according to the first gesture at the first distance, to perform a first function of the user interface element. A second aspect of the user interface element may be manipulated according to the first gesture at the second distance, to perform the first function of the user interface element.

In an implementation, a gesture may be received on a first position on a z-axis. A first function may be performed on a first user interface element based on the gesture. A movement of a hand along the z-axis may be detected. Control may be changed from the first user interface element to a second user interface element based on the movement of the hand along the z-axis. The gesture may be received at a second point on the z-axis and a second function may be performed on the second user interface element.

A system is disclosed that includes a database for storing sensor data from a camera, a camera sensor configured to send sensor data to the database, and a processor. The processor may be configured to detect a first gesture performed at a first distance from a reference point at a user and detect the first gesture performed at a second distance from the reference point at the user. The processor may be configured to manipulate a first aspect of a user interface element according to the first gesture at the first distance, to perform a first function on the user interface. The processor may manipulate a second aspect of the user interface element according to the first gesture at the second distance, to perform the first function of the user interface.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3A shows an example of a user gesture that scrolls through options in a user interface window or an application.

FIG. 3B shows an example of a user gesture that scrolls through a window in a user interface for an application as disclosed herein.

FIG. 4 shows an example process for manipulating a first aspect of a target and a second aspect of the target as disclosed herein.

FIG. 5A shows an example of a second gesture performed at a first distance as disclosed herein.

FIG. 5B shows an example of a second gesture performed at a second distance as disclosed herein.

FIG. 6 shows an example of a process to adjust a user interface from control of a first object according to a first gesture to control of a second object according to a second gesture as disclosed herein.

FIG. 7 shows an example process for performing a function on a target based on a z-axis position as disclosed herein.

FIG. 8 shows an example system for manipulating a first aspect of a target and a second aspect of the target as disclosed herein.

FIG. 9 shows an example of a system to adjust a user interface from control of a first object according to a first gesture to control of a second object according to a second gesture as disclosed herein.

FIG. 10 shows an example system for performing a function on a target based on a z-axis position as disclosed herein.

FIG. 11 shows an example process for manipulating a first aspect of a user interface element according to a first distance of a gesture and a second aspect of the user interface element according to the second distance of the gesture according to an implementation.

FIG. 12 is an example process for performing a function on a user interface element based on a z-axis position as disclosed herein.

FIG. 13 is an example system for manipulating a first aspect of a user interface element according to a first distance of a gesture and a second aspect of the user interface element according to the second distance of the gesture as disclosed herein.

### DETAILED DESCRIPTION

A gesture-based interface may attempt to emulate the effect of a computer mouse by implementing a clutching gesture to differentiate motions. For example, a closed or open hand may distinguish a scroll gesture between moving up or down to select items from a vertical list and scrolling that list. As disclosed herein, a depth camera may be utilized to sense movement of a user's hand, for example. The sensor data from the depth camera may be stored and extrapolated to determine a motion of a user's hand and/or a hand position. Principal joints of an individual (e.g., a hand, an elbow, a shoulder, a neck, a hip, a knee, an ankle, and/or a foot) may be identified and followed for the purposes for motion tracking or determining a gesture. The coordinates of the principal joints may be associated with coordinates in a three dimensional space. For example, the angle formed between a user's forearm and upper arm may be determined based on the coordinates. The determined angle may be compared to a threshold angle value. If the determined angle exceeds the threshold value, the arm's movement may correspond to one mode of interaction (e.g., scrolling a vertical list). Otherwise, the arm's movement may correspond to a different mode of interaction (e.g., choosing from among several options in a vertical list). The change in mode of interaction may be determined, therefore, independent of the length of the user's arm.

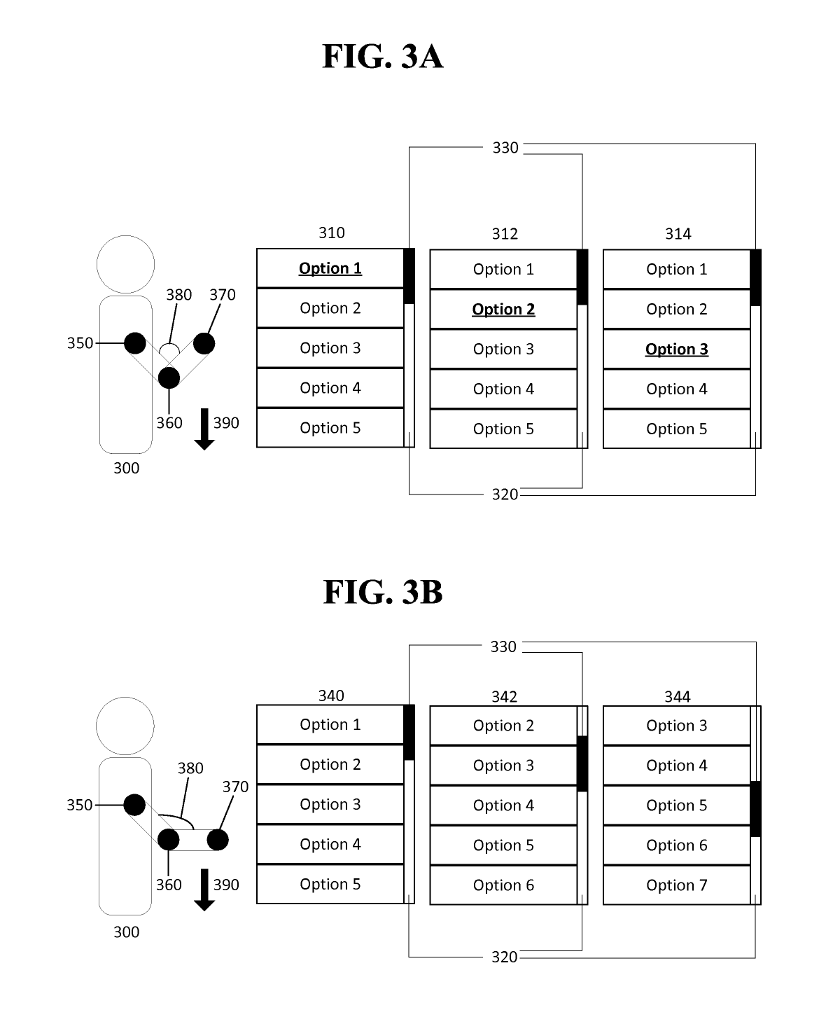

FIGS. 3A and 3B shows an example of an implementation disclosed herein. A user 300 may make a downward motion or gesture 390 with the user's arm and/or hand. In some implementations, an angle 380 may be determined as between the user's shoulder 350, elbow 360, and hand or wrist 370. In some configurations, a distance may be calculated between the user's hand or wrist 370 and a reference point such as the user's head or shoulder 350. The reference point may be used to determine the distance between the user's hand or wrist 370 and a display as determined by a camera such as a depth camera.

In FIG. 3A, the user 300 may be presented with a display on which a menu 310, 312, and 314 is shown with a scroll bar 320 and a scroll indicator 330 that shows the user's present position in the window that contains the menu 310. The user 300 may perform an initial gesture that causes a menu 310 to open. The first option, “Option 1,” may be highlighted or otherwise indicate to the user that it is the option currently selected. The same menu is shown at three different times during the user's 300 performance of the downward gesture or motion 390 as indicated by the menus 310, 312, and 314. In the gesture configuration shown in FIG. 3A, the user's gesture causes the system to move a selector from “Option 1” in the menu 310 at a first point in the gesture, to “Option 2” at a second point during the gesture 312. As the user continues the downward motion 390, the selector moves from “Option 2” of the menu 312 at the second point to “Option 3” in the menu 314 during a third point of the gesture.

In some configurations, a distance as described herein may not be utilized or may be utilized in combination with determining the angle formed by a user's arm, or portion thereof, relative to a reference such as the ground. If, for example, a person's arm is in an “L” shape (see, for example, FIG. 3A), then the angle formed between the vector formed by the person's elbow and hand with respect to a horizontal ground plane may be a consistent measure of movement regardless of how close or far the person is from the screen. Similarly, if the person's arm is outstretched (see, for example, FIG. 3B), the angle formed between a horizontal plane and the vector formed by the person's elbow and hand may be a consistent measurement of movement irrespective of proximity to a display. A vector may be formed as between other portions of a user's appendages and/or reference points. For example, a vector may be formed between a user's shoulder and hand. That vector may form an angle with the horizontal plane of the ground. Thus, a determination of the angle, as described here, may be used in lieu of or in addition to a distance calculation disclosed herein (e.g., with respect to FIGS. 3A and 3B) to determine which component of an interface is controlled.

One or more threshold values may be utilized to determine a range within which the system determines that it will move from one “Option” to the next. For example, depending on the number of “Options” available in the menu 310, the system may determine that for every ten centimeters of downward motion 390 detected from the user's gesture, it will scroll one menu “Option.” If, however, there are only two menu “Options,” then the system may dynamically set the threshold downward motion to be twenty-five centimeters. That is, when the system detects twenty-five centimeters of downward motion, it will move to the other menu “Option.” A threshold value may be based on the angle formed between a vector as between a user's arm and hand relative to the plane of the ground. The threshold value may establish a degree or range of degrees, beyond or within which, the system will move from one “Option” to the next (either up or down, left or right). For example, the system may determine that for every ten degrees of movement, it will scroll one menu “Option” similar to that described above with respect to a distance threshold value. The angle measurement threshold may be combined with the distance measurement threshold described above to introduce further refinement of the system.

In FIG. 3B, user 300 has extended the hand or wrist 370 toward, for example, a display or away from the user's body. Thus, the angle 380 between the user's shoulder 350, elbow 360, and hand or wrist 370 has increased. In some configurations, the change may be determined based on the distance between the user's hand or wrist 370 and a reference point such as the user's head or shoulders. As in FIG. 3A, the menu 340, 342, and 344 is shown with a scroll bar 320 and a scroll position indicator 330. The menus shown in FIG. 3B correspond to different views of the menu during the performance of the downward motion 390. In this case, the gesture causes the system to scroll the window instead of the selected menu option as in FIG. 3A, causing additional options to be shown that were not visible when the menu was operated as described with respect to FIG. 3A. As the user moves an arm downward, the system causes the window to scroll from a first position in the menu at 340 to a second position in the menu at 342 and from the second position to a third position in the menu at 344. Thus, the bent arm gesture in FIG. 3A causes the system to scroll selection of an item in a menu while the outstretched arm gesture causes the system to scroll the entire menu window. Notably, the gesture, a downward motion 390 with an arm, is the same in both FIGS. 3A and 3B. But, the change in the angle of the arm or distance between a hand and a reference point causes the effect of the gesture to change from scrolling the selection of an item in the menu to scrolling the menu window. Other functions besides scrolling may be altered and used according to implementations disclosed herein. More generally, as described herein, the user's hand is closer to the display in FIG. 3B than in FIG. 3A. Based on this difference, the gesture made by the user is used to control a different aspect or level of the interface, as disclosed in further detail herein.

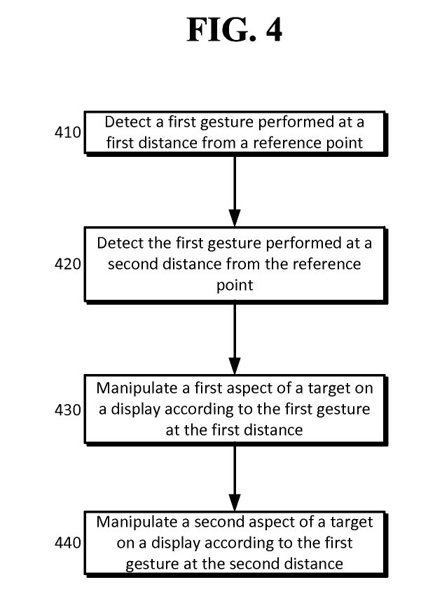

In an implementation, an example of which is provided in FIG. 4, a first gesture, performed at a first distance from a reference point at a user, may be detected at 410. The first gesture may be akin to that shown in FIG. 3A or, for example, the movement may be made laterally across the user's chest. The first distance may be the distance between a user's hand and the reference point, for example. The reference point may be a user's head, shoulder, or a display, for example. In many configurations, a display may be no more than 5 meters away from a user's position in a room and may provide a suitable reference point from which a distance calculation can be made. In addition, the implementations disclosed herein may be combined with multiple gestures. For example, a gesture made with an open hand and one made with a closed first may correspond to a different gestures and/or have a distinct effect, even though the arm movement remains similar to what is shown in FIGS. 3A and 3B.

Gesture detection may be performed using, for example, a depth camera sensor that senses the position and movement of items (including users) within the field of view of the depth camera. The received sensor data may be utilized to identify various components of the user's body (e.g., the user's hand, elbow, wrist, and the left and right arms). Sensor data may capture movement by comparing the sensor data from a first time reference and comparing it to sensor data from a second time reference. Similarly, the first gesture, performed at a second distance from the reference point at the user, may be detected at 420.

A first aspect of a target on a display may be manipulated according to the first gesture at the first distance at 430. A second aspect of the target may be manipulated according to the first gesture at the second distance at 440. As disclosed herein, a gesture may have multiple functions ascribed to it based on the distance between a reference point and the user's body part (e.g., a hand). A target may refer to a function that is a component of a graphical user interface such as a window scroll bar, a scroll selection, a scroll picture, a select picture (or other media content such as music, movies, electronic books or magazines, etc.). For example, as described with respect to FIGS. 3A-3B, different levels of scrolling may be manipulated by the same gesture performed at different distances. As another example, a picture viewing program may show several pictures, horizontally and linearly arrayed. A user gesture that moves an arm, bent at 90 degrees from left to right or right to left may scroll the picture viewing window to the right and to the left respectively. The user may desire to stop scrolling to the viewing window upon reaching the correct set of pictures. The user may then extend the arm such that it now forms a 140 degree angle (or causes the hand to be twice as far away from the reference point, the user's head, as when the arm is at a 90 degree angle). In the second position, the user may control selection of one of the pictures and/or move from one picture to the next, as compared to the gesture at the first distance which scrolls the entire window of pictures. An indication of the target may appear on a display. For example, if the user is scrolling the entire window that contains the pictures, the window may be outlined or otherwise highlighted. If the user is scrolling a selection of pictures, each picture on which the user is currently located or on which the function will be performed, may be highlighted.

Distinct functions for an application may be ascribed to the gesture at the first distance and the second distance respectively. At the first distance, for example, the user's movement from up to down with the arm may be associated with scrolling a list of songs. If the user moves the arm at the first distance from left to right, it may cause a song to be added to a playlist. If the user moves the arm at the second distance from left to right, it may cause playback of the song. At both the first and the second distance, movement of the arm up and down may cause scrolling from one song to the next. Thus, in this configuration it is the effect (e.g., the function) of the gesture that changes based on the distance.

In some configurations, the first aspect of the target may be a subcomponent of the second aspect of the target. For example, in FIG. 3A and FIG. 3B, the scrolling of the entire window may be deemed the second aspect of the target and the scrolling of a particular menu option may be deemed the first aspect of the target. The menu option is a subcomponent of the viewing window containing the menu options.

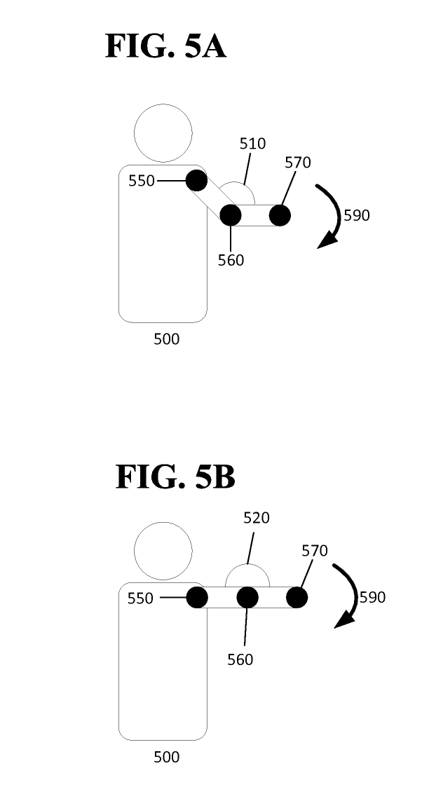

According to an implementation, a second gesture that is performed at the first distance from the reference point may be detected. The second gesture may be distinct from the first gesture. For example, the first gesture may be the one depicted in FIGS. 3A and 3B in which the user's hand may be extended toward the screen. A second gesture may be one similar to that depicted in FIGS. 5A and 5B. The user 500 (shown as facing forward in FIGS. 5A and 5B) may hold the arm in a bent form as measured, for example, by the angle 510 formed by the user's shoulder 550, elbow 560, and hand or wrist 570. A distance may be computed for the second gesture based on the distance between the user's hand 570 and the user's shoulder 550 or head. The user 500 may move the arm (e.g., shoulder 550, elbow 560, and hand or wrist 570) in a motion parallel to the floor or from a position that is parallel with the user to one that is forward relative to the user as indicated by the arrow 590. The second gesture, performed at a second distance from the reference point, may be detected as shown in the example in FIG. 5B. The user's entire arm is now almost or completely parallel with the floor. The angle 520 of the example in FIG. 5B is closer to 180 degrees. Thresholds for the angle computation or the distance calculation between the user's hand and reference point may be established to group the user's arm position in a certain category. For example, in FIG. 5A, an angle measurement between 10-60 degrees may be associated with a third aspect of a target on the display while an angle measurement between 61 and 180 degrees may be associated with a fourth aspect of the target on the display. Similar threshold values may be predetermined for the distance calculation such as a distance between 0.1 and 0.3 meters may be associated with the third aspect of the target while a distance of 0.4 and greater may be associated with the fourth aspect of the target. Thus, a third aspect of a target on the display may be manipulated according to the second gesture at the first distance and a fourth aspect of the target may be manipulated according to the second gesture at the second distance. For example, if the target is a file browsing window in a computer system. The first gesture, such as that shown in FIGS. 3A and 3B, may navigate files in a vertically scrolling manner at the first distance and on a file by file basis at the second distance. The second gesture, such as that shown in FIGS. 5A and 5B, may scroll the files horizontally at a first distance and on a file by file basis at the second distance.

The system may be calibrated based on an individual user to, for example, set threshold ranges or values as described above. For example, arm length may differ substantially between users if one user is a child and the other is an adult. An angle measurement may be used to complement a distance calculation or in place of a distance measurement to avoid body type discrepancies or variation between users of the same system. In some instances, a user may be identified, such as by facial recognition, and the user's body type (e.g., arm length, height, etc.) may be preset. In other instances, a new or naïve user of the system may be scanned to determine the user's body type information (e.g., height, arm length, approximate forearm length, approximate upper arm length, etc.).

In some configurations, a hierarchy may be defined for two or more user interface command functions associated with a computing device. The hierarchy may segregate user interface functions into one or more distinct layers. One of the layers may include the first aspect of the target and a second layer may include the second aspect of the target. For example, a hierarchy may define one layer as operating system commands (such as close window, minimize window, access menu options, etc.). Another layer may be an application layer. Commands in the application layer may be specific to a particular application. For example, a picture viewing application that shows a gallery of user-captured images may have application-specific commands (e.g., download picture, share picture, add picture to slideshow, etc.). The hierarchy may be configurable such that commands may overlap between different layers or to move commands from one layer to another layer. The hierarchy may refer to visual or logical layers of a user interface. For example, one layer may refer to one window shown on a computer screen and a second layer may refer to a second window on the same computer screen that is displayed as being in front of or behind the first window.

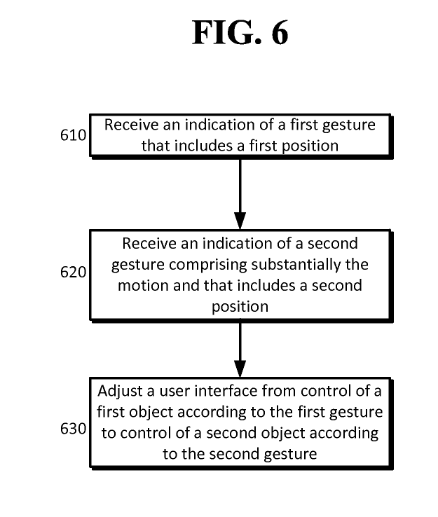

In an implementation, an indication of a first gesture that includes a motion may be received as shown in the example in FIG. 6 at 610. The motion may be associated with a function (e.g., save document, edit, delete, cut, copy, paste, etc.) The indication of the first gesture may include a first position of a hand relative to a reference point as described earlier. An indication of a second gesture may be received at 620. The second gesture may include substantially the motion of the first gesture. The indication of the second gesture may include a second position of the hand relative to and closer to the reference point. For example, the first gesture may be similar to the gesture shown in FIG. 3A, in which the user's arm is bent in an “L” shape. The motion may be a movement up and down. The second gesture may be, for example, the gesture shown in FIG. 3B, in which the arm is outstretched. The motion of the second gesture may be substantially the motion of the first gesture. That is, the up and down movement, for example, of the bent arm may span a half meter whereas the up and down movement of the second gesture, the outstretched arm, may span slightly more than a half meter to substantially less than a half meter (e.g., ten centimeters). Thus, an up and down motion may be substantially the same as another vertical motion, but it would not be substantially similar to a circular motion or a left to right motion, for example.

A user interface may be adjusted from control of a first object according to the first gesture to control of a second object according to the second gesture at 630. The first object may be, for example, a scroll bar of a user interface window or application window. The second object may be one that is contained within that window. For example, the second object may be a picture contained in an application. Control of the target may be indicated, for example, by highlighting the object that is currently being acted on by the first gesture and the second gesture. If a user performs the first gesture, then a display window on a computer interface may be indicated as being “active” such as by highlighting it. If the user performs the second gesture, the highlighting of the window may be removed and an object contained therein (e.g., a picture or image) may be highlighted. Thus, the second object may be a subcomponent of the first object. For example, the first object controls the display of the window in which the second object (e.g., files or pictures contained in the window) exists. Similarly, the first object may be a component of an operating system layer (e.g., the user interface) and the second object may be a component of an application layer (e.g., a save picture command, add to slideshow command, etc.). As another example, a first gesture may be an “L” shape of an arm as determined by depth camera sensor data. The distance between the user's hand and a reference point such as the user's head may be determined. A second gesture may be a straight or nearly straight (e.g., outstretched) arm. The “L” shape gesture and the outstretched arm gesture may be linked to one another such that the system may recognize that if the user performs one after the other that the user intends to adjust control of the interface from the first object to the second object (or vice versa).

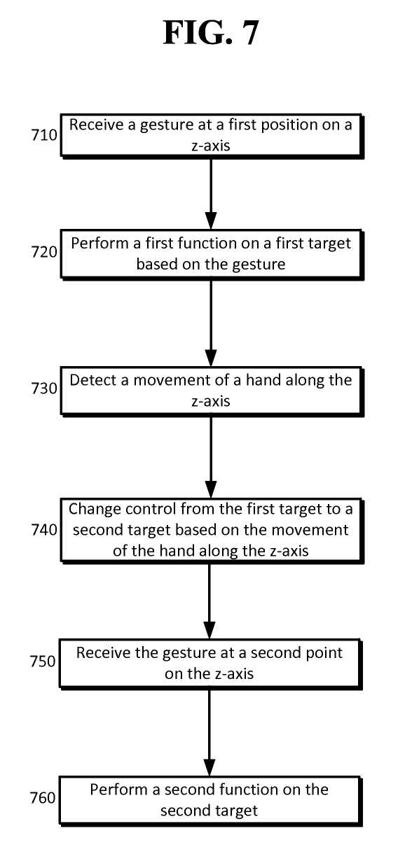

In an implementation, as shown in the example in FIG. 7, a gesture on a first position on a z-axis may be received 710. The z-axis may be defined relative to a user. For example, if the user is facing a display, the y-axis may be defined based on the user's upright position (e.g., based on the position of the user's legs and/or torso). The x-axis may be defined as the transverse of the user's torso. For example, based on the position of the user's shoulders, an x-axis may be defined as running parallel to the user's shoulders. The z-axis may be defined based on the orientation of the x- and y-axes and as being perpendicular or substantially perpendicular (e.g., within + or −10 degrees of 90 degrees) to both axes. The z-axis may be defined as between the user and a display in some instances.

A first function may be performed on a first target based on the gesture at 720. For example, the first function may be scrolling an application window that contains files such as a picture. A movement of a hand along the z-axis may be detected at 730. For example, the user may outstretch a hand from a first position on the z-axis to a second position on the z-axis. Control may be changed from the first target to a second target based on the movement of the hand along the z-axis at 740. For example, the first target may be a user interface window scroll and the second target may be a view command for files contained in the window. The gesture may be received at a second point on the z-axis at 750. That is, the gesture performed at the first position at 710 is the same as the gesture performed at 750 at a second position on the z-axis. For example, an up/down movement of the arm may be the gesture and the first position, as determined by the position of at least the hand relative to a reference point, may be that as a result of the arm being in a bent, “L” shape. With a hand outstretched, thereby causing the hand to be at a second position on the z-axis, the up/down movement of the arm may be repeated. The second position may, for example, allow a user enlarge one of many pictures contained within the user interface window (e.g., the first function on a first target). The user may move a cursor inside the window in, for example, an up/down or left/right manner. When the user stops at a particular picture, the user may change a conformation of the hand from, for example, an open hand to a closed first to indicate that the user would like the particular picture highlighted by the cursor enlarged. Thus, a second function on the second target may be performed at 760. As described earlier, the first target may be a subcomponent of the second target (e.g., a picture contained in a file browsing window. The first function and the second function may be the same (e.g., scroll function for the user interface window and a scroll function for a menu or submenu) of different.

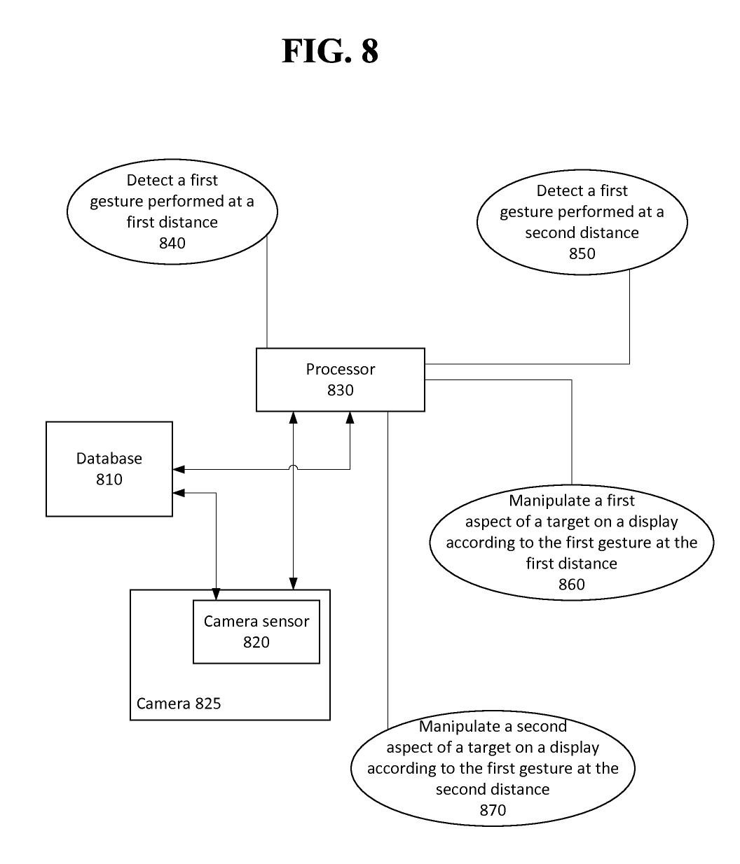

A system is disclosed according to the example shown in FIG. 8. For FIGS. 8-10, oval shapes indicate a function that may be performed, for example, by a processor while rectangular shapes refer to physical devices or components thereof. The system may include a database 810, a camera sensor 820, and a processor 830. The database 810 may store sensor data from a camera 825 that includes at least a camera sensor 820. The camera sensor 820 may be configured to send sensor data it obtains to the database 810 for later analysis. The sensor data may be received periodically or continuously. The processor 810 connected to the database 810 and/or the camera 825 may analyze only a portion of the data. For example if an individual is identified, the camera 825 may only analyze a region of the sensor data corresponding to the user's approximate location. The processor 830 may be configured to detect a first gesture performed at a first distance from a reference point at a user at 840 as described earlier. It may detect the first gesture performed at a second distance from the reference point at the user 850. The processor 830 may manipulate a first aspect of a target on a display according to the first gesture at the first distance 860 and manipulate a second aspect of the target on a display according to the first gesture at the second distance 870 as described above.

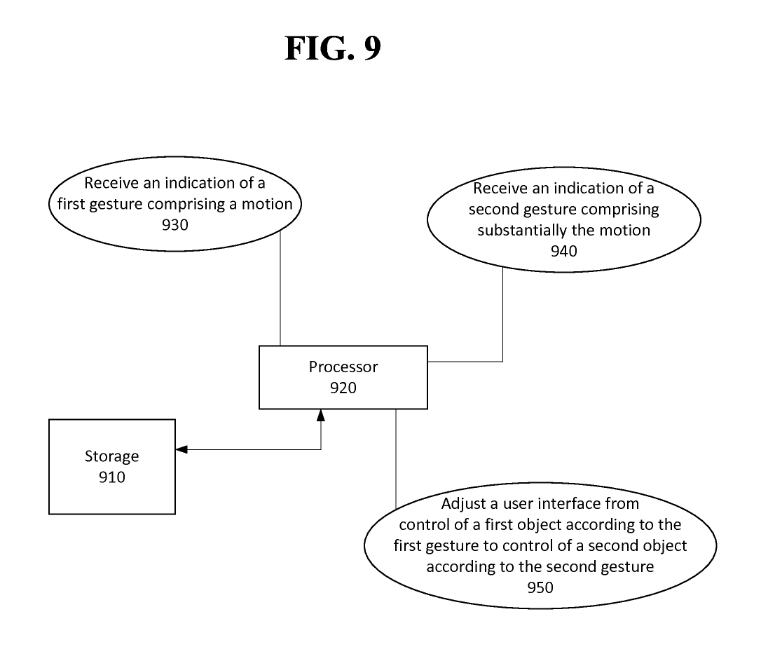

In an implementation, an example of which is shown in FIG. 9, a system is provided that includes a computer-readable storage device 910 for storing data pertaining to two or more gestures. For example the data may be images captured by a camera sensor or depth camera data. The images may be analyzed by a processor 920 to determine the identity of objects in the camera's field of view or movement of any objects in the camera's field of view. The processor 920 may be connected to the storage device 910 and configured to receive an indication of a first gesture that includes a motion at 930. The indication of a first gesture may include a first position of a hand relative to a reference point. The processor 930 may receive an indication of a second gesture that includes substantially the motion at 940 as described earlier. The indication of the second gesture may include a second position of the hand relative to and closer to the reference point. The processor 920 may adjust a user interface from control of a first object according to the first gesture to control of a second object according to the second gesture 950.

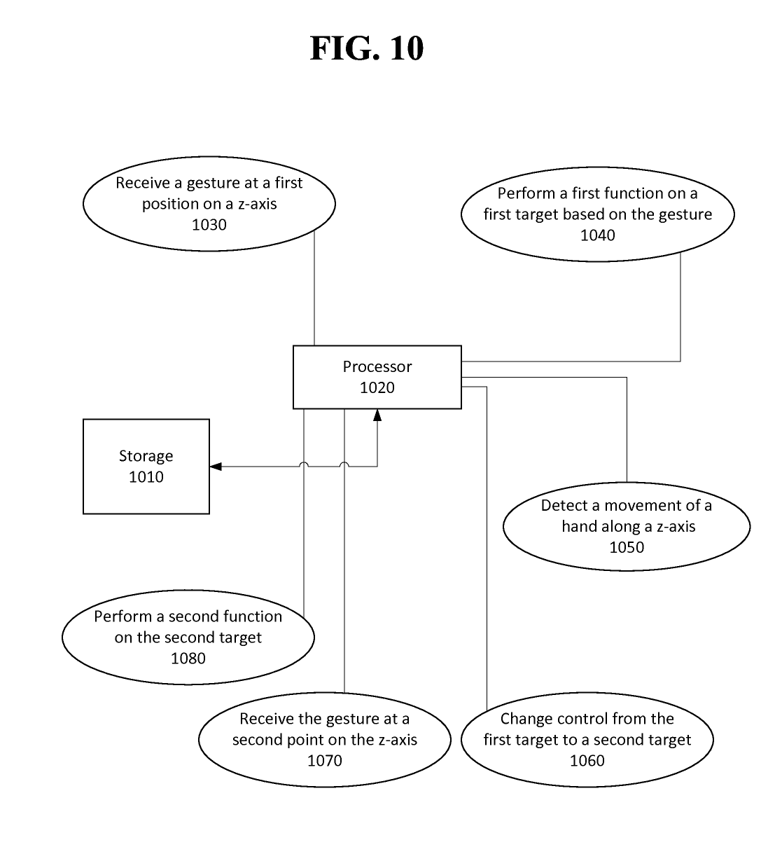

According to an implementation, a system is provided that includes a computer-readable storage device 1010 for storing data pertaining to two or more gestures and a processor 1020 connected thereto, as shown by the example in FIG. 10. The processor 1020 may be configured to receive a gesture on a first position on a z-axis 1030 and perform a first function on a first target based on the gesture 1040. The processor 1020 may detect a movement of a hand along the z-axis 1050 and change control from the first target to a second target based on the movement of the hand along the z-axis as described earlier 1060. The processor may receive the gesture at a second point on the z-axis 1070 and perform a second function on the second target 1080.

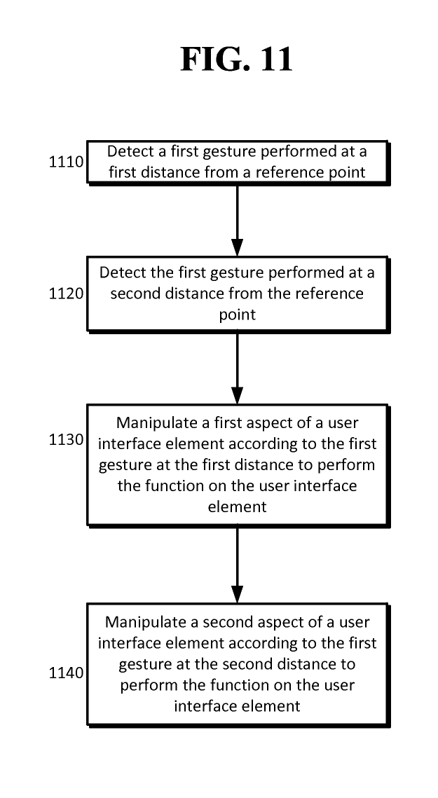

FIG. 11 shows an example process for manipulating a first aspect of a user interface element according to a first distance of a gesture and a second aspect of the user interface element according to the second distance of the gesture according to an implementation. A first gesture performed at a first distance from a reference point at a user may be detected at 1110. The first gesture performed at a second distance from the reference point at the user may be detected at 1120 as described earlier. A first aspect of a user interface element may be manipulated according to the first gesture at the first distance to perform a function on the user interface element at 1130. For example, in FIGS. 3A and 3B, the user interface element may be the menu window. More generally, a user interface element may refer to a visual component that is displayed to a user such as a container window, a browser window, a menu window, a text terminal, a menu bar, a context menu, an icon, a text box, a window, a slider, a scroll bar, and/or a tab. A first aspect may refer to the user interface element being controlled or manipulated. In FIG. 3A, for example, the first aspect of the user interface element may be specific menu options in the menu (e.g., the user interface element). A second aspect of the user interface element may be manipulated according to the first gesture at the second distance, to perform the function on the user interface at 1140 to perform the function on the user interface element. The function may refer to a scroll command, such as the examples provided in FIGS. 3A and 3B. The second aspect of the user interface element may be the menu window. Thus, the function (e.g., scrolling) may be performed on the second aspect (e.g., the menu window) of the user interface element (e.g., the menu).

In some configurations, an indication of the user interface element may be received based on whether user interface element is being manipulated according to the first gesture at the first distance or the first gesture at the second distance. For example, a menu window may be highlighted if it is being manipulated and a menu option may be highlighted if it is being manipulated.

The first gesture may be determined based on an angle formed between a first plane formed by a user's shoulder and a user's elbow and a second plane formed between a user's elbow and a user's hand. In some instances, the gesture may be based on an angle formed between a first vector that utilizes a user's elbow and shoulder as reference points to form the vector and a second vector that utilizes a user's elbow and a user's hand.

As described earlier, a second gesture may be detected that is performed at a first distance from the reference point and at a second distance from the reference point. The second gesture may be distinct from the first gesture. A third aspect, as described earlier, of the user interface element may be manipulated according to the second gesture at the first distance and a fourth aspect of the user interface element may be manipulated according to the second gesture at the second distance. The third and fourth user interface elements may correspond to additional menu options, icons, etc. In some instances, a function performed on the third and fourth aspects of the user interface element may be different from that performed on the first and second aspects. For example, the first and second aspects may be manipulated according to a scrolling function while the third and fourth aspects of the user interface may be manipulated according to a copy and/or paste function.

As described earlier, a hierarchy may be defined by an application, an operating system, or a runtime environment, for example. The first aspect of the user interface element may be in a first layer of the hierarchy of user interface elements and the second aspect of the user interface element may be in a second layer of the hierarchy. The hierarchy may be based on software levels (e.g., an operating system level and an application level). The hierarchy may, in some configurations, not be tied to the system's software. For example, the hierarchy may be defined based on a location. If the device is at a first location, the hierarchy may be defined in a first configuration and if the device is at a second location, the hierarchy may be defined as a second configuration.

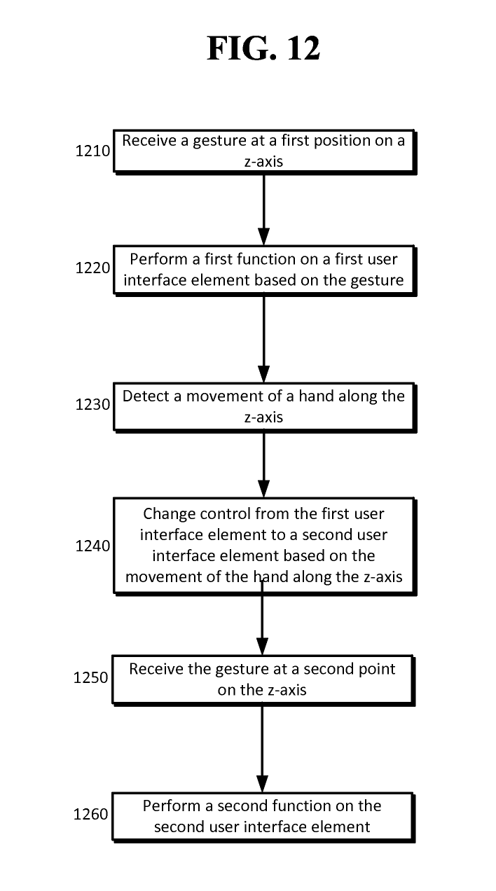

An example process for performing a function on a user interface element based on a z-axis position as disclosed herein is shown in FIG. 12. A gesture on a first position on a z-axis may be received at 1210 as described earlier. A first function may be performed on a first user interface element based on the gesture at 1220. The first function may be a command to scroll individual menu options (e.g., the first user interface element). A movement of a hand may be detected along the z-axis at 1230. Control may be changed from the first user interface element to a second user interface element based on the movement of the hand along the z-axis at 1240. For example, the second user interface element may be a menu window. The gesture may be received at a second point on the z-axis at 1250. A second function may be performed on the second user interface element at 1260. For example, the second function may be a command to scroll the menu window. The first and second functions may overlap (e.g., be the same or similar, such as a scroll function) or may be distinct functions. The first user interface element may be a subcomponent of the second user interface element.

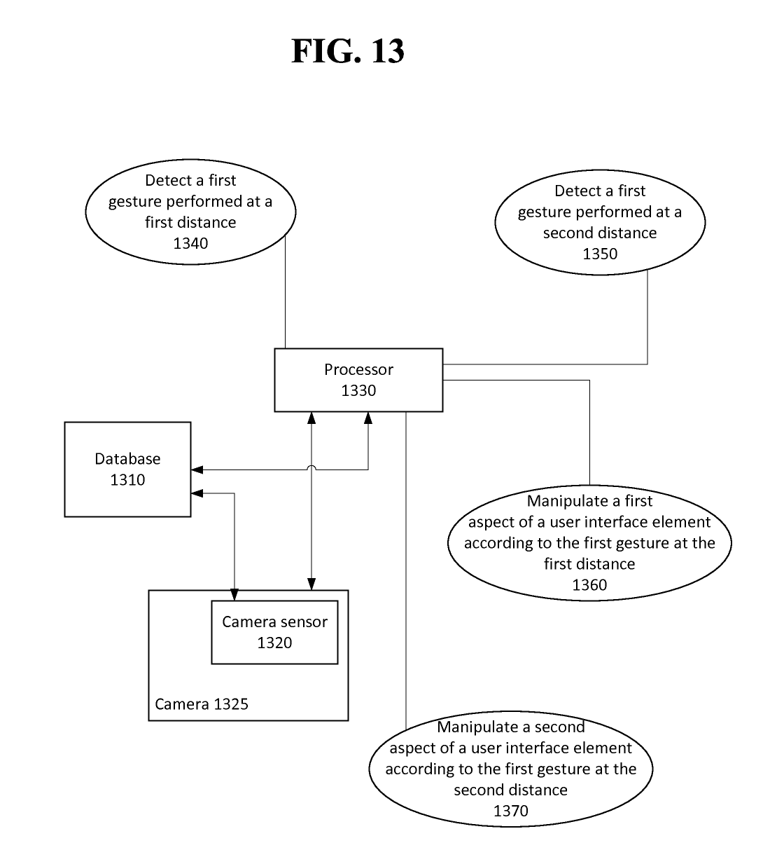

FIG. 13 is an example system for manipulating a first aspect of a user interface element according to a first distance of a gesture and a second aspect of the user interface element according to the second distance of the gesture as disclosed herein. The system may include a database 1310 for storing sensor data from a camera 1325, a camera sensor 1320 configured to send sensor data to the database 1310, and a processor 1330. The processor 1330 may be configured to detect a first gesture performed at a first distance from a reference point at a user 1340 and detect the first gesture performed at a second distance from the reference point at the user 1350 as described earlier. The processor 1330 may manipulate a first aspect of a user interface element according to the first gesture at the first distance 1360, to perform a first function on the user interface. The processor 1330 may manipulate a second aspect of the user interface element according to the first gesture at the second distance 1370, to perform the first function of the user interface.

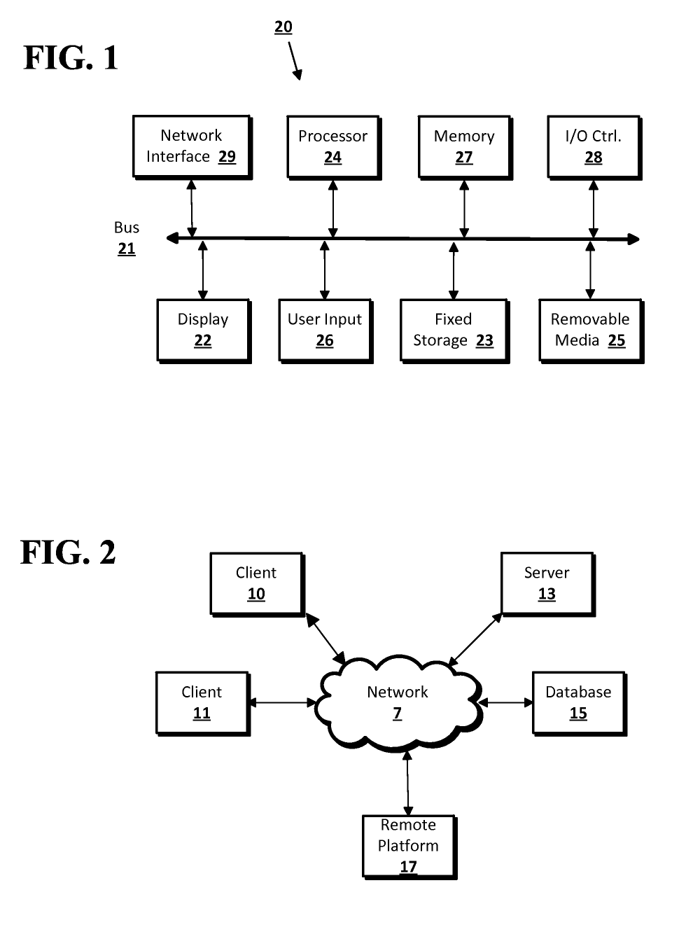

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's performance score, a user's work product, a user's provided input, a user's geographic location, and any other similar data associated with a user), or to control whether and/or how systems disclosed herein receive sensor data from, for example, a camera. In addition, certain data may be treated in one or more ways before it is stored or used, so that personally identifiable information is removed. For example, a user's identity may be treated so that no personally identifiable information can be determined for the user, or a user's geographic location associated with an instructional course may be generalized where location information is obtained (such as to a city, ZIP code, or state level), so that a particular location of a user cannot be determined. Thus, the user may have control over how information is collected about the user and used.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1-19. (canceled)

20. A computer-implemented method comprising:
obtaining multiple images that are taken by a camera;
determining that the images show a user performing a gesture that involves the user facing the camera and moving between (i) a first position, in which one of the user's hands is extended a first distance in front of their body, and (ii) a second position, in which the user's hand is extended a different, second distance in front of their body;
based on determining that the images show the user performing the gesture that involves the user facing the camera and moving between the first position and the second position, selecting an input; and
providing the input to an application.

21. The computer-implemented method of claim 20, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's forearm and upper arm, in the first position, and (ii) a second angle formed between the user's forearm and upper arm, in the second position.

22. The computer-implemented method of claim 20 comprising:
determining a value that corresponds to a length of the user's arm; and
determining a distance threshold based at least on the value,
wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining that the second distance exceeds the first distance by the distance threshold.

23. The computer-implemented method of claim 20, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's forearm and a plane defined by the ground, in the first position, and (ii) a second angle formed between the user's forearm and the plane defined by the ground, in the second position.

24. The computer-implemented method of claim 20 comprising:
determining, as a third distance, a distance between the user and a display associated with the camera; and
wherein selecting an input comprises selecting, from among multiple inputs that are each associated with (I) a user gesture and (II) a respective distance, the input that is associated with (i) the gesture and (ii) the third distance.

25. The computer-implemented method of claim 20 comprising:
determining whether the user's hand is in an open or closed position,
wherein selecting an input comprises selecting, from among multiple inputs that are each associated with (I) a user gesture and (II) a position of a hand as either open or closed, the input that is associated with (i) the gesture and (ii) the position of the user's hand.

26. The computer-implemented method of claim 20, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's upper arm and the user's body, in the first position, and (ii) a second angle formed between the user's upper arm and the user's body, in the second position.

27. A non-transitory computer-readable storage device having instructions stored thereon that, when executed by a computing device, cause the computing device to perform operations comprising:
obtaining multiple images that are taken by a camera;
determining that the images show a user performing a gesture that involves the user facing the camera and moving between (i) a first position, in which one of the user's hands is extended a first distance in front of their body, and (ii) a second position, in which the user's hand is extended a different, second distance in front of their body;
based on determining that the images show the user performing the gesture that involves the user facing the camera and moving between the first position and the second position, selecting an input; and
providing the input to an application.

28. The storage device of claim 27, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's forearm and upper arm, in the first position, and (ii) a second angle formed between the user's forearm and upper arm, in the second position.

29. The storage device of claim 27, wherein the operations comprise:
determining a value that corresponds to a length of the user's arm; and
determining a distance threshold based at least on the value,
wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining that the second distance exceeds the first distance by the distance threshold.

30. The storage device of claim 27, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's forearm and a plane defined by the ground, in the first position, and (ii) a second angle formed between the user's forearm and the plane defined by the ground, in the second position.

31. The storage device of claim 27, wherein the operations comprise:
determining, as a third distance, a distance between the user and a display associated with the camera; and
wherein selecting an input comprises selecting, from among multiple inputs that are each associated with (I) a user gesture and (II) a respective distance, the input that is associated with (i) the gesture and (ii) the third distance.

32. The storage device of claim 27, wherein the operations comprise:
determining whether the user's hand is in an open or closed position,
wherein selecting an input comprises selecting, from among multiple inputs that are each associated with (I) a user gesture and (II) a position of a hand as either open or closed, the input that is associated with (i) the gesture and (ii) the position of the user's hand.

33. The storage device of claim 27, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's upper arm and the user's body, in the first position, and (ii) a second angle formed between the user's upper arm and the user's body, in the second position.

34. A system comprising:
one or more data processing apparatus; and
a computer-readable storage device having stored thereon instructions that, when executed by the one or more data processing apparatus, cause the one or more data processing apparatus to perform operations comprising:
obtaining multiple images that are taken by a camera;
determining that the images show a user performing a gesture that involves the user facing the camera and moving between (i) a first position, in which one of the user's hands is extended a first distance in front of their body, and (ii) a second position, in which the user's hand is extended a different, second distance in front of their body;
based on determining that the images show the user performing the gesture that involves the user facing the camera and moving between the first position and the second position, selecting an input; and
providing the input to an application.

35. The system of claim 34, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's forearm and upper arm, in the first position, and (ii) a second angle formed between the user's forearm and upper arm, in the second position.

36. The system of claim 34, wherein the operations comprise:
determining a value that corresponds to a length of the user's arm; and
determining a distance threshold based at least on the value, and
wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining that the second distance exceeds the first distance by the distance threshold.

37. The system of claim 34, wherein determining that the images show the user performing the gesture that involves the user facing the camera and moving between (i) the first position, in which one of the user's hands is extended the first distance in front of their body, and (ii) the second position, in which the user's hand is extended the different, second distance in front of their body, comprises determining (i) a first angle formed between the user's forearm and a plane defined by the ground, in the first position, and (ii) a second angle formed between the user's forearm and the plane defined by the ground, in the second position.

38. The system of claim 34, wherein the operations comprise:
determining, as a third distance, a distance between the user and a display associated with the camera; and
wherein selecting an input comprises selecting, from among multiple inputs that are each associated with (I) a user gesture and (II) a respective distance, the input that is associated with (i) the gesture and (ii) the third distance.

39. The system of claim 34, wherein the operations further comprise:
determining whether the user's hand is in an open or closed position,
wherein selecting an input comprises selecting, from among multiple inputs that are each associated with (I) a user gesture and (II) a position of a hand as either open or closed, the input that is associated with (i) the gesture and (ii) the position of the user's hand.
